(19) United States
(12) Patent Application Publication
(10) Pub. No.: US 2003/0177120 A1
(43) Pub. Date: Sep. 18, 2003

(54) Procedures and programs of a network matching system

(76) Inventor: Leo Stodolsky, Munich (DE)

Correspondence Address: KURT SHAFFERT, 5517 UPPINGHAM, CHEVY CHASE, MD, 20815, US

(21) Appl. No.: 10/094,895

(22) Filed: Mar. 12, 2002

(51) Int. Cl. G06F 7/00

(52) U.S. Cl. 707/9

(57) ABSTRACT

A system is provided whereby sought-for and available individuals or things are matched by the internet or other computer networks. This is achieved by posting a standardized form called a “profile” to the network, where the profile describes and characterizes the individual or thing which is sought for or is available. The profiles are then processed electronically to find matches. Close matches are reported to the parties involved, and if desired a channel of communication is set up. The procedure may be conducted anonymously or publicly, and in a simple version of the public procedure may be thought of as an “internet classified ad”. Advantages of the system are the unprecedented scope of the search procedure allowed by the scale of the internet; and, further when individuals are concerned, the overcoming of barriers related to shyness or confidentiality allowed by the anonymity of the process.

### BACKGROUND OF THE INVENTION

Searching for a person or a thing is a very common activity. Similarly the making known of the existence or availabiity of a person or thing that might be sought-for is a common and important action. Particularly where the object in question is a person, there is an important psychological element involved in the process of search and offer. Shyness, the need for discretion, social or related constraints, may often inhibit the making known of a person with certain qualities perhaps sought by another.

The advent of computer networks opens a new dimension for such activities, whether they involve persons or things, and in the present invention we wish to disclose a means of realizing this new potential. In particular the mass computer network brings a new dimension to such problems in two ways.

1) Quantitatively, the mass interconnectivity of great numbers of individuals means that the scope of the search/offer process is potentially orders of magnitude greater than in the past, if an adequate methodology/technology for handling these numbers is available.

2) Qualitatively, the impersonal and if desired anonymous working of the network can greatly reduce the pyschological, societal or confidentiality barriers often involved in making contacts between individuals, or other matters where confidentiality is required.

### BRIEF SUMMARY OF THE INVENTION

Briefly, the invention deals with point 1) by disclosing a universal, standardized, computer-based system capable of handling great numbers of cases rapidly. It deals with point 2) by disclosing how confidentiality may be assured and how the participation of an individual in the system may be done with a minimum of involvment if desired. In particular we shall describe how an individual need take no more positive action than the posting of an anonymous description to become part of the process.

Finally, a simplifed version of the invention appropriate to cases where high levels of confidentiality are not necessary is disclosed. This may be viewed as an “electronic classified ad”

The invention consists of procedures and computer programs for the purpose of matching up sought-for persons and things with existing or offered ones. A standardized description for each category called a profile is filled in by a user and posted to the network. This posting may be accomplished by opening the user's computer to the network, by being collected by a network robot or sent to a collecting station. A computerized system reports on matches to similar profiles describing sought-for persons and things and requests decisions on further steps, which may finally include direct communication between the participating parties. Provision can be made if desired for a highly secure degree of anonymity and security of information, and for procedures involving a step-by-step revelation of information necessary for further contacts. The system may operate from an individual's or an organization's computers and servers via network connections, or from websites specialized for this purpose.

In the simplified form of the method (“electronic classified ad”) the standardized profiles may adapted so as to be easily accessed and searched for desired characteristics by conventional network search engines or by a “peer-to-peer” program.

### DETAILED DESCRIPTION OF THE INVENTION

Reduced to its simplest form, the invention involves simply placing a description of a person or thing on the network, and seeing if there is a closely matching description already present. If this is true, and if one is a description of availablity and the other of search, the means to a contact are created.

The implementation involves four basic steps: 1) A first submission containing in particular a search or description profile 2) Collection, matching and reporting to the parties on their submissions 3) Exchanges between interested parties resulting in more information and detail, usually on an anonymous level 4) Provision for direct, usually non-anonymous, contact between interested parties. We shall describe these steps and their associated implementation and procedures in turn.

Step one involves the initial submission. A “submission” is a computer file placed on the network, in an initial submission containing a standardized description of the person or thing sought or being made available. In the further steps, after the initial submission, further submissions may be used for communication between the interested parties.

We call the standardized description just mentioned a “profile”, with “search profiles” indicating something sought-for, and “description profiles”, indicating something being offered or available. Aside from the indication of purpose, i.e for “search” or “description”, the two types of profiles are essentially identical and standardized. This is to allow rapid computerized comparison between “search” or “description” profiles.

A preferred realization of the standardization of the profiles is as follows. A large list of questions, each one with a fixed set of possible answers is prepared and is offered to the user by appropriate software. The person or organization filling out a profile is termed the “owner”. In filling out the profile the owner may choose both the questions to answer as well as the answers to a given question. In the subsequent computerized matching of search and description profiles, the questions chosen as well as their answers are evaluated in arriving at a “goodness of match” between “search” and “description” profiles. The questions and their different answers are numbered or coded in such a way as to permit easy computer comparison between profiles. A number of variations on this basic scheme are possible, for example the owner may be asked to provide a weighting of certain questions according to their importance to him. The set of questions used in making up the profiles may be updated and extended by the operators of the system as the need arises, including employing suggestions offered by users.

To illustrate the nature of questions making up a profile we give some examples of questions for the case where the profile describes a person.

Sex, age or age range, height or height range, weight or weight range, hair color, other elements of physical description, time period of availability, marital status, children, major language spoken, other languages, geographic location, educational level, music interests (favorite song or composer), preferred clothing, travel interests, career aims, favorite foods, films, books, sports, hobbies.

For the first question there would be two answers, Male or Female. For the second question, age, there would be a choice of answers ranging say from 0-100, where for a search profile several answers might be selected. The geographic location question would have many subdivisions so that the choice “Europe” from among the world's major regions would lead to a further question offering the countries of Europe, and then to regions with the selected country.

In addition to the profile, a submission must or may contain a number of other features for proper operation. Since it is not intended that submissions are necessarily sent to any particular address, but rather are simply made available to the network, a mark or code indicating that the submission is intended for the system should be included. This will generally be provided automatically by the software, and enable collection by the system's “robots” or “web crawlers”. (We call the totality of computer programs, computers, collecting mechanism and so forth used to accomplish the functions we describe as the “system”.)

Evidently a submission should contain a code or mark indicating if it is intended for search or description.

Next a submission must include an identifying name, called the “ID” by which it will be known to opposing parties and which will remain identified with the person or thing in question throughout the various procedures.

In addition the owner will choose or receive a confidential password allowing the owner and only the owner to access materials relevant to his submission. Evidently one of the tasks of the system will be to check ID's and passwords for duplication and to suggest alternatives in the case of duplicates. Also it is clear that an owner may have mulitple submissions, each one with its own ID.

It may be desirable to be able to place messages and informal communications in a submission, thus the file(s) contain provisions for the inclusion of such materials. Similarly pictorial and graphic material can be included.

Finally for use in the steps following an initial submission where communication between parties is being established, the submission may contain the ID of an addressee, as well as that of the owner.

Since in many applications confidentiality or secrecy is desirable provision is made for optional encryption by the software preparing a submission.

We now turn to the second step, that of collecting, processing and reporting on submissions.

A given submission may generally, after the first communication containing a profile, lead to repeated communications as contact with interested parties is established. For this reason the submission file has provision for informal (as opposed to standardized ) messages and graphic material and provision for directing it to a particular addressee.

Alternatively, separate types of submission files maybe be used after the initial submission. In particular for the procedure of establishing direct communication between interested parties where private information such as names or addresses may be exchanged special forms and procedures are necessary where the system mediates such requests.

In a preferred embodiment of such a procedure, one of the parties fills out a form requesting an opposing party who is anonymous but identified by an ID to supply information necessary for direct contact.

It will be appreciated that contact may be broken off easily and without prejudice by any participant up to the point where anonymity has been given up.

We now discuss the collection of the profiles and subsequent submissions. In the case where the profiles are sent directly to a computer provided by the system for this purpose, no special collection procedure is necessary. In the event of heavy traffic on the system, it may be advantageous to have a wide geographic distribution of such computers to speed reception of the profiles.

When the profiles are posted to an ordinary open server, either in encrypted form or not, a specifically designed robot or “web crawler” can be used to recognize the profile (by a tag or code, possibly hidden or encrypted) and to read it to the computer or program where further processing is to take place. The practicability of such robots is well known through their use in gathering information for internet search engines (eg Yahoo, AltaVista) and there are extensive discussions of robot design for particular purposes.

As a final point concerning the posting and collection of the profiles, we note that each profile must be assigned some kind of mark or serial number to identify it and to allow accessing of results and the giving of further instructions and communications in connection with it. In a “private mode” where anonymity and secrecy is desired, this identification symbol may be used as a password, or additionally a separate password may be assigned; and also these identification marks and passwords may be given in encrypted form. Depending on security and convenience considerations, these marks and passwords may be generated either by the owner and his software or by the central system when the profile is collected.

Evidently the central system must check that these marks and passwords are not already assigned to another active profile and ask for corrective action should this be the case.

In a preferred embodiment the programs for the filling in of the profiles, for generating an identification mark/and or password, for the posting to an open server or to a computer belonging to the system, and optionally for encryption, are combined in one convenient software package.

After collection of the profiles, further processing is performed by the central computers of the system. The programs operating there examine the various options on the profiles, take the appropriate dispositions in accordance with the options, assign and/or check the identifying marks and passwords if necessary, and perform the comparison between “description” and “search” profiles. The programs doing this preferably assign a “goodness of match” figure to every pairing of profiles, as well as optionally to certain sectors of the profiles, for example as total number of points or on a scale from 0 to 100. The matching or comparison procedure will consist essentially of comparing the same positions in the description and search profiles and returning a positive score when they agree. Thus, for example, under “name your three favorite pop songs” (optionally from a prepared list) a positive score is assigned according to how many songs agree in the two profiles, and zero otherwise.

After the comparisons are performed, the next step is the preparation of a report on the results. The report may be accessed by the owner by using the identification mark or password and may be optionally encrypted. The report will contain such information as the number of matches above a certain level of “goodness of match” for the whole profile or certain sectors of it, the distribution of various elements such as geographic, financial, age and experience and so forth.

It is to be anticipated that the comparison procedure will sometimes yield a very large, unwieldy number of possible matches to consider. Therefore provision is made for the restarting of the comparison procedure with more restrictive conditions if the number of reported matches is unwieldy by for example narrowing the matching conditions, raising the threshold of “goodness of match”, and so on.

In a further step the owner may request the provision of a communication channel with opposite parties satisfying certain criteria, (e.g. match above 90%, certain geographic location, and so forth) and to be identified him or herself by an arbitrary name (e.g. “match number 1 above 90%”) or by their actual or other name. The establishment of such a channel can then be offered to the opposite party, who may or may not make use of it.

In the same way the owner of a profile may request the release of certain privacy levels of his profile to certain opposite parties identified by such names and/or fulfilling such criteria. All these steps and communications are enabled by use of the identifying mark or password and may be carried out anonymously and with encryption if desired.

Such requests and communications will typically take place in a logical space set aside for the given profile in the computers of the system, and accessed by means of the identifying mark or password.

In this manner, and presumably usually with successive iterations, the most interesting matches may be filtered out, leading ultimately to the revelation of the information necessary for direct personal contact between the parties, through the network or otherwise.

An important and extensive part of the operation of the system will be the handling and management of the traffic to and within it, such as setting up and checking of passwords and names, providing for encryption, managing of communication areas, means for eliminating unwanted profiles and information and so forth. While no single one of these or related functions is novel or unusually difficult, as a system they represent a complex construction and their careful management and coordination is essential to the success of the whole.

As mentioned aboce it is evident that the entire methodology disclosed is not restricted to persons; and may be applied to many other areas, including objects, materials, services, intellectual problems, physical and intellectual property, plants and animals and so forth, with relatively small modifications, principally occasioned by the need to now have various different categories of profiles.

Finally we would like to disclose a simplified form of the methodology which could be considered the creation of an “electronic classified ad”. It would not have the features of privacy described previously but would have the advantages of 1) simplicity and 2) being usable in conjuction with existing or future normal search engines, or in a peer-to-peer system.

The simplified system involves application of the standardized profile or description for a person or thing, but not directly involving a matching of two similarly constructed profiles. Present internet search engines like Altavista, Yahoo and others work on the simple principle of looking for and recognizing words, names, symbols and their combinations as found on the network. They then return the addresses of webpages, usually in the form of links, where these are found. In this manner a publicly displayed profile, containing certain desired characteristics could be located by such a conventional search engine. For example, assume one were searching for a person with a certain skill, years of experience, located in a certain geographic area, and requiring a certain salary range, and available at a certain time. And assume some person has posted an offer profile containing this information and matching these requirements. The searcher could enter the skill, the minimum years of experience, the location, the salary range, time period, plus an identifying mark for a job profile, in a conventional search engine and the engine would find the profile with these characteristics, and return the address or link. This procedure would not have many of benefits of the matching procedure through a central system, such as the features of anonymity and discretion, the possibility of a private discussion channel or the detailed quantitative analysis of the profiles. On the other hand it would use existing search engines (in combination with the standardized profile) and so would be simple to set up and attractive to users not in need of the full features of the matching system, or wishing to avoid the costs or complexity associated with the more elaborate system. In this mode the standardized form of the profile is particularly advantageous since the search engine may be instructed to look for certain standard expressions or symbols labeling the profile (e.g. “job profile”, “rental property profile” . . .) and/or characteristic of the features being sought.

What I claim is:

1. Procedures and software whereby a description of a person or thing (“profile”) is posted to the internet, said description is compared with other descriptions desirous of finding matches, and the results are reported to the respective owners of the descriptions, with means enabling purveyance of further information and contact, the whole being preferably conducted in an anonymous, automatic and secure manner, including measures for encryption.

2. Procedures and software in accordance with claim 1 whereby said descriptions consist of elements from a set of standardized questions and their answers, with a possible weighting as to the importance of the question to the owner, the questions and their answers being numbered or coded in such a fashion so that different profiles may be easily compared by computer.

3. Procedures and software in accordance with claim 1 where the owner of a description chooses or is assigned a name or sign (ID) for identifying materials relevant to his submission and also chooses or is assigned a confidential password, allowing secure access to the relevant material.

4. Procedures and software in accordance with claim 1 whereby submissions are posted to the internet by being placed in a suitable directory in the owner's computer or local network open to the internet, or by being sent to a collecting station of the system; the submissions then being collected for processing by an automated, continuously operating system such as a robot or a “web crawler”.

5. Procedures and software in accordance with claim 1 where the collected descriptions are compared by the system to determine the matching between descriptions and their potential matches, said matching being based on which questions are used and their answers, and a report is produced on each match where a figure of merit characterizing “goodness of match” between it and opposing descriptions is exceeded; said report then being communicated to the owners of the descriptions either by email or by public posting where they may be accessed by means of the ID and password.

6. Procedures and software in accordance with claim 5 whereby the owner of a description may request a change in the conditions of “goodness of match” and/or alter the questions used in the description, in order to narrow or widen the scope of the search.

7. Procedures and software in accordance with claim 1 whereby the recipient of the report of a match may, by using the ID of the matching party, may communicate with him or her through the system, request or provide a more detailed description, or further information such as messages, graphics and pictures, and optionally means for entering into direct contact.

8. Procedures and software in accordance with claim 1 whereby the system will communicate a request on the part of the owner of a given ID for direct contact to the owner of another ID, and the latter granting permission, will transmit the necessary contact information, such as an email address or telephone number, as provided by the party or parties.

9. A computer file (submission) and the software package for producing it, in accordance with claim 1, optionally with encryption, where the file is structured so as to contain any or all of the following elements:
A) an identifying mark showing that it is intended for the system, enabling it to be picked up by a robot or “web crawler”, or a search engine B) a name or mark (ID) for the owner of the submission, C) a series of questions and their answers chosen from a standardized set, identified by their codes or symbols and optionally carrying a code indicating a privacy or secrecy level, D) a space for messages and informal communications, E) provision for the attachment of pictorial or graphical material F) a password or secret code for the owner if necessary, F) an indicator as to whether the file is a “search” or “description” submission, G) a name or mark (ID) of an addressee.

10. A set of computer programs in accordance with claim 1 which handles and manages the traffic to, from, and within the system, including receiving said submissions, assigning and/or checking their identifying marks or passwords, providing means of accessing reports and giving instructions, releasing secrecy levels to designated parties, handling requests for direct communication, handling encryption/decryption, cancelling or modifying submissions, and when desired destroying all information relevant to a given ID.

11. A set of computer programs in accordance with claim 1 which carries out comparisons between opposing profiles and issues a report on these comparisons.

12. A computerized report in accordance with claim 1 on the results of the comparisons to a description, containing such information as “goodness of match” between a description and an opposing descriptions, optionally above a requested level, breakdowns of same according to certain sectors when desired, statistics on the types of matches and which optionally requests further action such as modifying the nature of the report or extending or restricting the search conditions.

13. An “electronic classified ad” in the form of a “search” or “offer” description in standardized form, and labeled as such by an identifying mark or tag enabling it to be recognized by public network search engines or software employed by the individual user.

14. An “electronic classified ad” in accordance with claim 13 containing contact information.

15. A computer program or software system in accordance with claim 13 designed for use by the individual user which can search for the tag and make comparisons with a profile which is entered into said program or software system.
